(19) United States
(12) Patent Application Publication
(10) Pub. No.: US 2014/0129032 A1
(43) Pub. Date: May 8, 2014

(54) GENETIC LEARNING FOR ENVIRONMENTAL CONTROL AUTOMATION

(71) Applicant: Think Automatic, LLC, Seattle, WA (US)

(72) Inventor: Stephen HARRIS, Seattle, WA (US)

(73) Assignee: Think Automatic, LLC, Seattle, WA (US)

(21) Appl. No.: 14/073,695

(22) Filed: Nov. 6, 2013

Related U.S. Application Data
(60) Provisional application No. 61/723,625, filed on Nov. 7, 2012.

(51) Int. Cl. G06N 99/00

(52) U.S. Cl. CPC G06N 99/005
USPC 700/275

(57) ABSTRACT

Disclosed is a method and apparatus for an environmental control system in which a genetic learning algorithm creates scenes and scene triggers and in which a fitness function scores the scenes through end-user interaction.

### CROSS-REFERENCE TO RELATED APPLICATIONS

This application claims the benefit of United States provisional patent application Ser. No. 61/723,625, filed Nov. 7, 2012, which is hereby incorporated in its entirety for all purposes.

### FIELD OF THE INVENTION

This application relates to environmental control systems.

### BACKGROUND

Existing environmental control systems can be used to control individual environmental control devices, such as lights, doors, audio equipment, HVAC equipment, and the like, though the convenience of controlling one device at a time through an environmental control system is not much different than controlling each device via its conventional controller (such as a light switch, a thermostat, a garage door opener, a stereo, etc.).

Existing environmental control systems can be programmed to implement “scenes” by sending commands to multiple environmental control devices. A scene may be programmed for a particular time of day, so that activating a remote control in the morning may trigger a set of lights, setting the HVAC to a certain level, turning on a stereo to a radio station, and starting a coffee maker, whereas activating the remote control in the evening may trigger a different scene which may open the garage door, turn on a different set of lights, set the HVAC to a different level, and the like.

However, scenes can be difficult to program and having two scenes instead of one adds to the system complexity. Exceptions to the program can be programmed, though this results in greater programming complexity as well as remote controls with multiple activation options to account for the exceptions—further adding to the overall system complexity. As a result, changing scene programs can be complex, often requiring service by technicians to accomplish what should be routine changes.

### BRIEF DESCRIPTION OF THE DRAWINGS

FIG. 1 is a network and device diagram illustrating exemplary computing devices configured according to one embodiment.

FIG. 2 illustrates Scene Triggers, Scene Candidates, and Scenes, according to one embodiment.

FIG. 3 is a functional block diagram of an Automation Server computing device, according to one embodiment.

FIG. 4 is a functional block diagram of the Automation Server Datastore, according to one embodiment.

FIG. 5 illustrates a flow of an example Device Registration Routine, according to one embodiment.

FIGS. 6A-6B illustrate a flow of an example Scene Manager Routine, according to one embodiment.

FIG. 7 illustrates a flow of an example Fitness Function subroutine, according to one embodiment.

FIG. 8 illustrates a flow of an example Genetic Operator subroutine, according to one embodiment.

### DETAILED DESCRIPTION

It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list.

Disclosed herein are various embodiments for an environmental control system in which a genetic learning algorithm creates scenes and scene triggers and in which a fitness function scores the scenes through end-user interaction.

Genetic learning algorithms iteratively execute a fitness function against a genetic representation of a problem to be solved. The fitness function selects the best set of outcomes (defined according to the genetic representation of the problem) in each “generation” or round of testing, combines parameters from the best outcomes, and returns to the starting point to select the best set of outcomes in the then-current generation. The process may iterate for a fixed number of generations or until the outcome stabilizes within a certain range. A well designed genetic learning algorithm may arrive at a stable outcome so long as the parameters of the problem to be solved remain unchanged. If the parameters of problem to be solved are perturbed, the genetic learning algorithm may iterate toward a new, potentially stable, outcome. Genetic learning algorithms are typically utilized in contexts where the computational demands of a traditional mathematical approach would be too great.

However, defining the genetic representation of the problem and the fitness function is not straight-forward. If the fitness function is too rigorous, the genetic learning algorithm may arrive too quickly at and not move off of a clearly sub-optimal solution; if the fitness function is not rigorous enough or if the genetic representation of the problem includes too many variables or non-linear interaction among the variables, the genetic learning algorithm may never arrive at or may arrive to slowly at a stable solution.

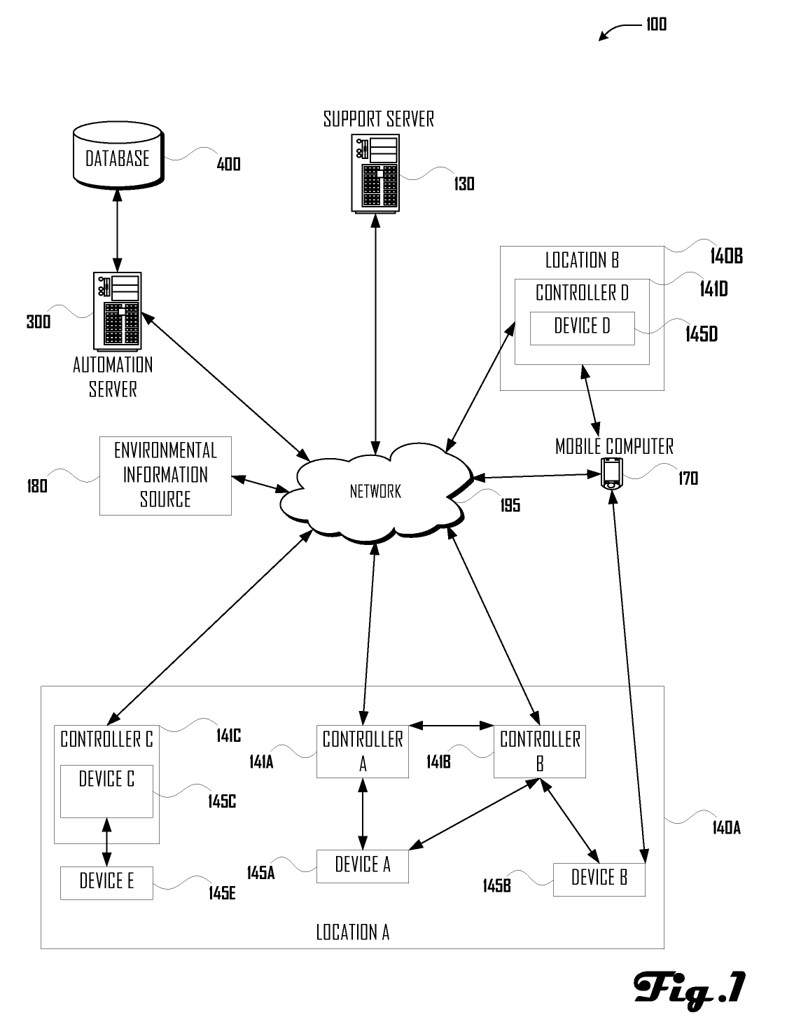

FIG. 1 illustrates an Automation Environment 100 comprising exemplary computing devices configured according to one embodiment. In FIG. 1, an Automation Server 300, a Support Server 130, a Mobile Computer 170, Controllers 141A-D, and Devices 145A-E, connected to a Network 195, such as the Internet, an Ethernet or X10 network (which may be wireline or wireless), and/or directly to one another. For the sake of convenience, Controllers 141A-D may be discussed collectively as Controllers 141 or as a single Controller 141; similarly, Devices 145A-E may be discussed collectively as Devices 145 or as a single Device 145.

Connection to the Network 195 or direct connection between computing devices may require that the computers execute software routines which enable, for example, the seven layers of the OSI model of computer networking or equivalent in a wireless phone or wireless data network. The Network 195 comprises computers, network connections among the computers, and software routines to enable communication between the computers over the network connections. Communication among the various computers and routines may utilize various data transmission standards and protocols such as, for example, the application protocol HTTP and/or the X10 protocol. Transmitted data may encode documents, files, and data in various formats such as, for example, HTML, XML, flat files, and JSON.

Also illustrated in FIG. 1 are Locations 140A-B, referred to collectively as Locations 140 or as a single Location 140. Examples of Locations 140 are physical locations such as a building, set of buildings, an area, or the like. The Locations 140 comprise Controllers 141 and Devices 145. The Automation Server 300 and the Support Server 130 may be within a Location 140 or may be remote, relative to one or more of the Locations 140. In some embodiments, the Automation Server 300 may be incorporated into another computer, such as into a Controller 141.

Devices 145 comprise a range of Devices 145, for example: “dumb” light bulbs attached to a “smart” controllable socket or power outlet, stereo equipment, audio/video output devices (with playlists, pause/play/forward/rewind), garage door openers, door and window sensors, HVAC equipment, and the like. Devices 145 may include computers and may be physically integrated with Controllers 141, such as Controller 141C integrated with Device 145C, or the Devices 145 may be physically separate from the Controller 141, such as Device 145A being physically separate from Controller 141A and Controller 141B. A single Controller 141 may control more than one Device 145, such as Controller 141B controlling Device 145A and Device 145B. A single Device 145 may be controlled by more than one Controller 141, such as Device 145A being controlled by Controller 141A and Controller 141B.

As discussed herein, Devices 145 can experience “Events” and “States,” such as Events 405 and States 410. Examples of Events 405 and States 410 (without distinguishing between the two) include a Device 145 turning on or off, a change in power output (such as a change in the level of a dimmable light), a change in power output relative to a threshold (a change below a threshold may be a State 410; a change above a threshold may be an Event 405), a door or window being open or closed (as, for example, detected by a sensor or as controlled by an opening mechanism), starting, stopping, or pausing playback, changing a channel or playlist, a change in a temperature setting determined by the Device 145, and similar. Events 405 are generally more significant than changes in State 410, though an Event 405 in one Device 145 may “merely” be a change in State 410 in another Device 145. Events 405 can be Triggers 430 for Scenes 420, whereas States 410 are not Triggers 430 for Scenes 420 (“Scenes 420” are defined further below; in its simplest form, Scenes 420 comprise one or more Devices 145 in a Location 140 being set to particular Event 405 and State 410 settings). An Event 405 from a first Device 145 which is also a Trigger 430 for a Scene 420 (not all Events 405 are necessarily Triggers 430), will trigger a Scene 420, which Scene 420 will (usually) involve a change in State 410 and/or Event 405 for second, third, etc., Devices 145. Triggered Scenes 420 are implemented via Device Commands 435, which may be translated by the Command Translator 440 records into commands in the format, syntax, or language utilized by the Device 145 (and/or a Controller 141 controlling a Device 145). The Device Commands 435 may be formatted according to, for example, XML syntax and schema. An Event 405 which is not a Trigger 430 will not cause a change in State 410 and/or Event 405 for second, third, etc., Devices 145.

Events 405 and States 410 in Devices 145 are reported to the Automation Server 300 by Controllers 141 via Device Reports 455. Whether information in a Device Report 455 relates to an Event 405 or a State 410 may, for example, be according to the Device Report 455, which Device Report 455 may include flags, parameters or other values to communicate the distinction. Whether information in a Device Report 455 relates to an Event 405 or a State 410 may, for example, be determined by the Automation Server 300 by cross-referencing an identifier of a Device 141, such as a Device Type 445 record in a Device Report 455, which Device Type 445 record may be utilized to determine whether the information in the Device Report 455 relates to an Event 405 or State 410. The distinction between Events 405 and States 410 and the definition of which Events 405 are Triggers 430 may be according to instructions from or associated with the Device 145, a device driver, a Controller 141, or through user preferences received by the Automation Server 300 and/or the Scene Manager Routine 600 and/or the Human UI 370. Events 405 and States 410 may be controlled directly at the Device 145, without a Controller 141, provided, however, that for a Device 145 to participate in the system disclosed herein, the Events 405 and States 410 experience by the Device 145 must at least be reported or reportable to the Automation Server 300 by a Controller 141 through a Device Report 455.

The Controllers 141 illustrated in FIG. 1 are computers (ranging from relatively simple single-purpose computers to general purpose computers) which communicate with the Automation Server 300, the Support Server 130, and with other Controllers 141 (such as the Mobile Computer 170 or between Controller 141A and Controller 141B) and which control the Devices 145. The Controllers 141 may control the Devices 145 and the Events 405 and States 410 thereof, such as by issuing Device Commands 435, and must at least report Events 405 and States 410 to the Automation Server 300; reporting may occur, for example, as Events 405 and States 410 occur, in response to polling, or on a schedule.

The Controllers 141 may be part of the Devices 145, such as Controller 141C illustrated as being part of Device 145C and Controller 141D illustrated as being part of Device 145D. The Controllers 141 may be physically separate from the Devices 145, such as Controller 141A being physically separate from Device 145A or Controller 141B being physically separate from Device 145A and Device 145B. The Controller 141 may control the Device 145 and poll the Device 145 for information by issuing commands to the Device 145, such as via commands transmitted by wireline or wireless technologies (including X10, IR, WIFI, Ethernet, Zigbee, Z-Wave, Insteon, and other wireline and wireless technologies) or the Controller 141 may control the Device 145 by, for example, controlling a controllable power outlet or switch to which the Device 145 may be connected. More than one Controller 141 may control and/or report on more than one Device 145. For example, Controller 141A in Location 140A controls Device 141A while Controller 141B in Location 140A controls Device 145A and Device 145B.

A combined Controller 141 and Device 145 may, for example, take the form factor of a wall switch which a user can toggle to control another Device 145 connected to the wall switch, such as a light bulb in a controllable socket. Toggling the wall switch may, for example, be an Event 405 which is a Trigger 430 for a Scene 420 which turns on the light bulb at a first power level. A second Scene 420 associated with the wall switch Event 405/Trigger 430 may turn the light bulb to a second (for example, dimmer) power level and may turn on a playlist in a stereo; the second Scene 420 may be accessed by toggling the wall switch additional times (see discussion, below, regarding the Scene Manager 700 routine). A dimming-control on the wall switch or in the controllable socket, controlled independently or via the wall switch, may control the power level of the light bulb; a Controller 141 in the assembly may report the power level to the Automation Server 300 via a Device Report 455, which change in power level may be an Event 405 and a Trigger 430 for the second Scene 420. This example is illustrated in FIG. 1 by Controller 141C, physically integrated with Device 145C, and controlling Device 145E. Another example of a combined Controller 141 and Device 145 is a video playback Device 145 (such as a computer, DVD, and/or streaming media player) which comprises a Controller 141 which allows the video playback Device 145 to report Events 405 and States 410 which may be Triggers 430 for other Scenes 420 and which allows the video playback Device 145 to be controlled remotely, by the Automation Server 300.

Whether physically joined or separate, the Controller 141 and Devices 145 must be logically connected, with the Controller 141 able to control and/or report the Device 145 Events 405 and States 410. The Controller 141 must be able to control and/or obtain Events 405 and States 410 for the Devices 145 controlled by the Controller 141, which Events 405 and/or States 410 are reported by the Controller 141 in Device Reports 455 to the Automation Server 300. The Controller 141 and/or the Automation Server 300 must be able to issue Device Commands 435 to the Devices 145 and/or Controllers 141 to implement Scenes 420.

The Mobile Computer 170 illustrated in FIG. 1 may be used as a Controller 141 and may comprise a cellular telephone, smartphone, laptop computer, tablet computer, or other computer which is configured to control Devices 145, either directly (as illustrated by the connection to Device 145B) or via the Automation Server 300 (via Network 195) or, as illustrated, via a connection to another Controller 141 (such as Controller 141D).

The Automation Server 300 is illustrated herein as comprising software routines for a Webserver 360, dbMS 365 (short for “database management system”), a Human UI 370 (“UI” being short for “user interface”), and a Device UI 375. The Support Server 130 comprises software routines for a Webserver, a Human UI, and a Device UI, among other routines. The Mobile Computer 170 comprises software routines for a Human UI and the Device UI, among other routines. The Controllers 141 comprise software routines for a Human UI and the Device UI, among other routines. The Devices 145 may comprise software routines for a Device UI, among other routines.

The Human UI, such as Human UI 370, may be, for example, a user interface for a human in any of the Controllers 141, a webpage (enabled by a browser routine), the display output by an application on a Mobile Computer (such as on Mobile Computer 170), and the user interface of a remote control for a Device 145; the Human UI 370 provides an interface between the Controllers 141 and a human operator, either directly or via the Automation Server 300.

The Device UI 375 may comprise Event 405 and State 410 information and Device Commands 435 communicated to/from the Device 145 as well as commands required to control the Controllers 141 and Devices 145 and to thereby execute Scenes, such as Scene 420, across a heterogeneous population of Controllers 141 and Devices 145, all communicating with the Automation Server 300. Scenes 420 comprise one or more Devices 145 in a Location 140 being set to particular Event 405 and State 410 settings. Scenes 420 are implemented by the Automation Server 300 issuing a set of Device Commands 435, which may be converted by the Command Translator 440 into commands in the syntax native or unique to the Controller, which then implements the commands in the Device 145 via the Device UI. Scenes 420 may be triggered by Triggers 430; Triggers 430 comprise certain Events 405 experienced by Devices 145, which Events 405 have been defined to be Triggers 430. Device Commands 435 comprise the commands available to be issued to a Device 145 by a Controller 141 and/or by the Automation Server 300; Device Commands 435 may relate to Events 405 or States 410.

The Webserver 360 (and a Webserver in the Support Server 130 and/or Controllers 141) may be used to provide communication between and among the Automation Server 300, the Support Server 130, and the Controllers 141. The Webserver 360 may also provide backend services for the various Human UI 370 and Device UI 375 instances.

FIG. 1 illustrates the Automation Server 300 as being connected to a Database 400 computer. This paper discusses components as connecting to the Automation Server 300 or to the Database 400; it should be understood that such connections may be to, through, or via the other of the two components (for example, a statement that a computing device connects with or sends data to the Automation Server 300 should be understood as saying that the computing device may connect with or send data to the Automation Server 300 and/or the Database 400). Although illustrated as separate components, the servers and databases may be provided by common (or separate) physical hardware and common (or separate) logic processors and memory components.

The Database 400 is illustrated as comprising database records for Events 405, States 410, Scene Candidates 415, Scenes 420, Scene Trigger Scores 425, Triggers 430, Device Commands 435, Command Translators 440, Device Types 445, Trigger Map 450, Device Reports 455, Device IDs 460, Trigger Group 465, and Attributes 470. All records referred to herein (in the Database 400 and other computer components) may be represented by a cell in a column or a value separated from other values in a defined structure (such as in a flat text file). Though referred to herein as individual records, the records may comprise more than one database or other entry. The records may be, represent, or encode numbers, binary values, logical values, text, or similar; the records may be configured to derive information from other records through operations such as joins, filters, concatenations, mathematical operations, string operations, date-time operations, tests, and similar.

Also illustrated in FIG. 1 is a Support Server 130. Not shown, the Support Server 130 may be connected to a database similar to Database 400. Similar to the Automation Server 300, the Support Server 130 may comprises software routines for a Webserver, a Human UI, a Device UI, and a dbMS. The Support Server 130 may perform some of the operations described herein as being performed by the Automation Server 300.

Also illustrated in FIG. 1 is an Environmental Information Source 180. The Environmental Information Source 180 may be a source of information regarding environmental conditions, such as the weather, ambient light, ambient temperature, and the like. The Environmental Information Source 180 may be in a Location 140 or may be remote. The Environmental Information Source 180 may be a weather station, a weather reporting device, a weather service, or the like.

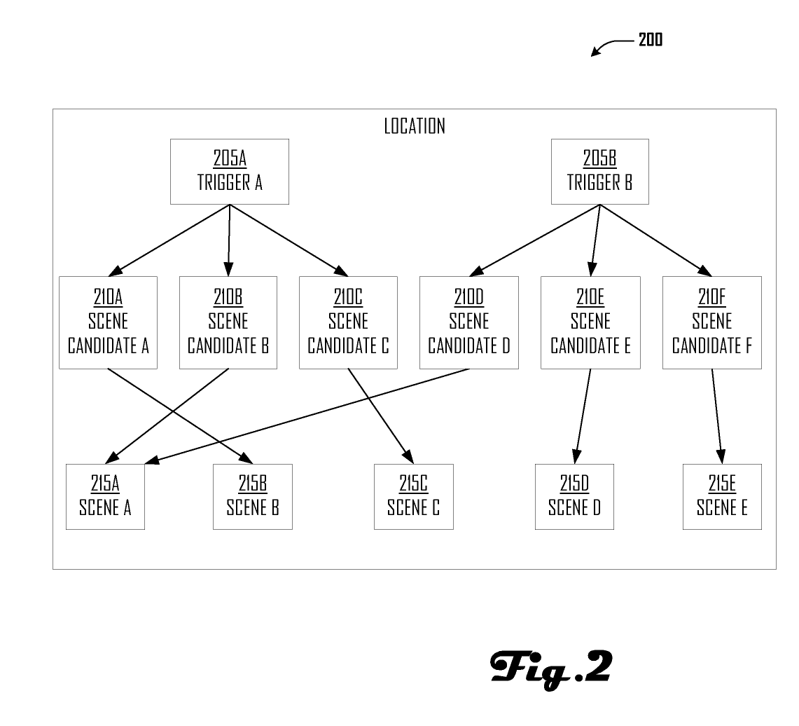

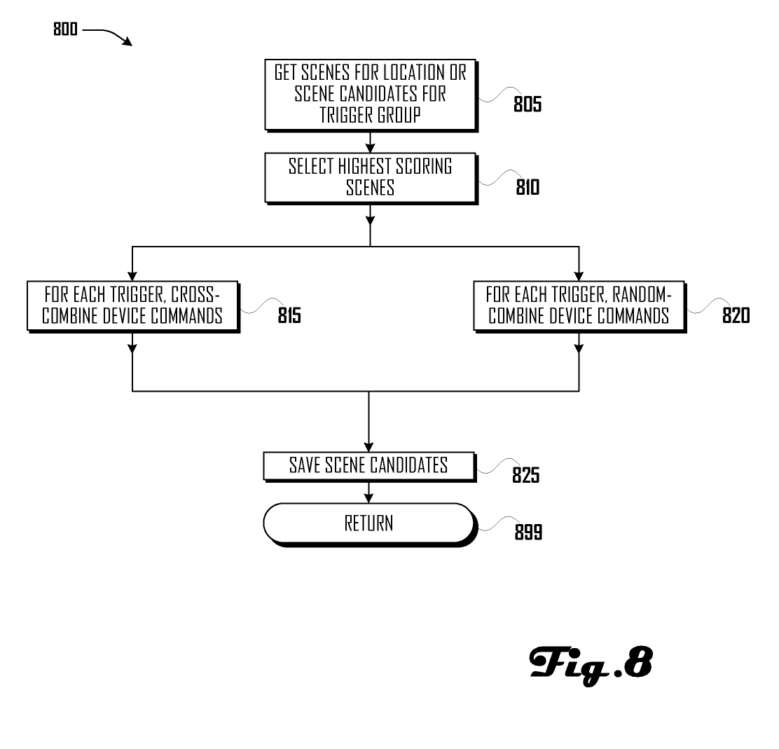

FIG. 2 illustrates Trigger, Scene Candidate, and Scene Scenarios 200. FIG. 2 illustrates Trigger 205A and Trigger 205B, which both may be examples of Trigger 430 records. As illustrated in FIG. 2, Trigger 205A may be associated with and may be a Trigger 430 for Scene Candidates 210A-210C, while Trigger 205B may be associated with and may be a Trigger 430 for Scene Candidates 210D-210F. FIG. 2 illustrates that the Scene Candidates 210 may each be associated with a Scene 420, such as Scenes 215A-215E. FIG. 2 illustrates that different Scene Candidates 415, such as Scene Candidate 210B, and Scene Candidate 210D, may each be associated with the same Scene, Scene 215A. FIG. 2 is discussed further in relation to FIG. 8 and the Genetic Operator Subroutine 800.

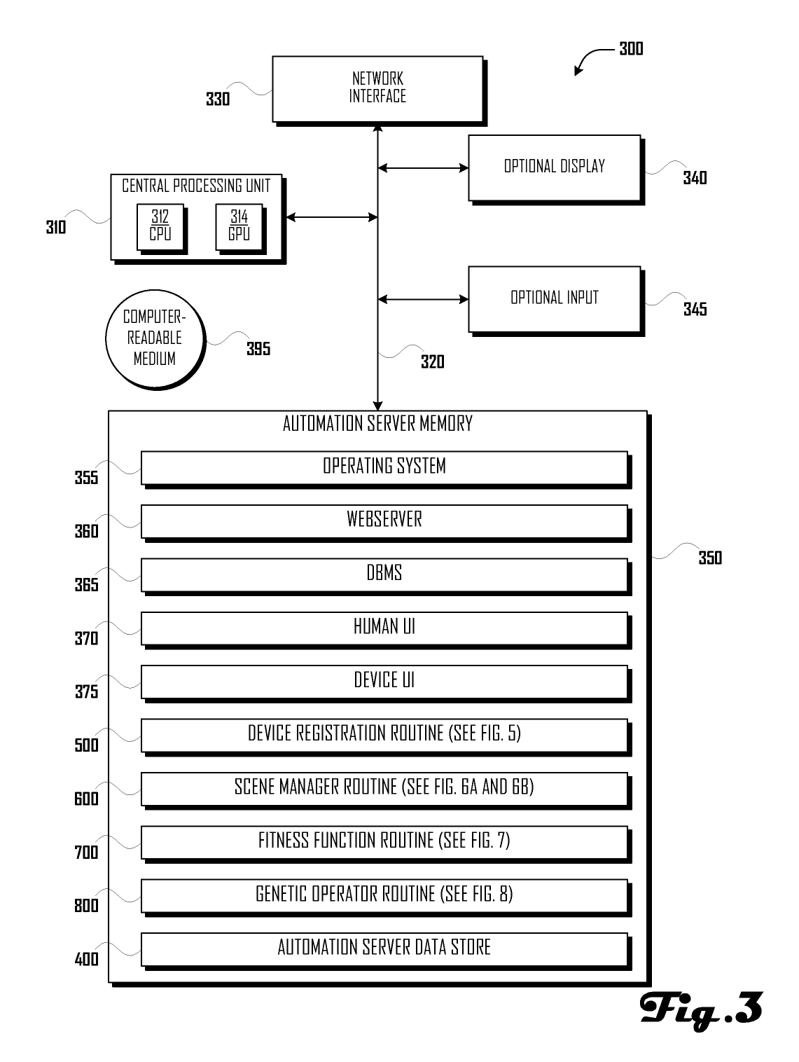

FIG. 3 is a functional block diagram of an exemplary Automation Server 300 computing device and some data structures and/or components thereof. The computing device 300 in FIG. 3 comprises at least one Processing Unit 310, Automation Server Memory 350, and an optional Display 340, all interconnected along with the Network Interface 330 via a Bus 320. The Network Interface 330 may be utilized to form connections with the Network 195 and to send and receive radio frequency (“RF”) and other wireless and wireline signals.

The Automation Server Memory 350 generally comprises a random access memory (“RAM”), a read only memory (“ROM”), and a permanent mass storage device, such as a disk drive or SDRAM (synchronous dynamic random-access memory). The Automation Server Memory 350 stores program code for software routines, such as, for example, a Webserver 360 routine, a DBMS 365 routine, a Human UI 370 routine, a Device UI 375 routine, a Device Registration Routine 500, a Scene Manager Routine 600, a Fitness Function Subroutine 700, and a Genetic Operator Subroutine 800, as well as browser, webserver, email client and server routines, camera, gesture and glance watching applications, other client applications, and database applications. In addition, the Automation Server Memory 350 also stores an Operating System 355. These software components may be loaded from a non-transient Computer Readable Storage Medium 395 into Automation Server Memory 350 of the computing device using a drive mechanism (not shown) associated with a non-transient Computer Readable Storage Medium 395, such as a floppy disc, tape, DVD/CD-ROM drive, memory card, or other like storage medium. In some embodiments, software components may also or instead be loaded via a mechanism other than a drive mechanism and Computer Readable Storage Medium 395 (e.g., via Network Interface 330).

The computing device 300 may also comprise hardware supported input modalities, Input 345, such as, for example, a touchscreen, a keyboard, a mouse, a trackball, a stylus, a microphone, accelerometer(s), compass(es), RF receivers (to the extent not part of the Network Interface 330), and a camera, all in conjunction with corresponding routines.

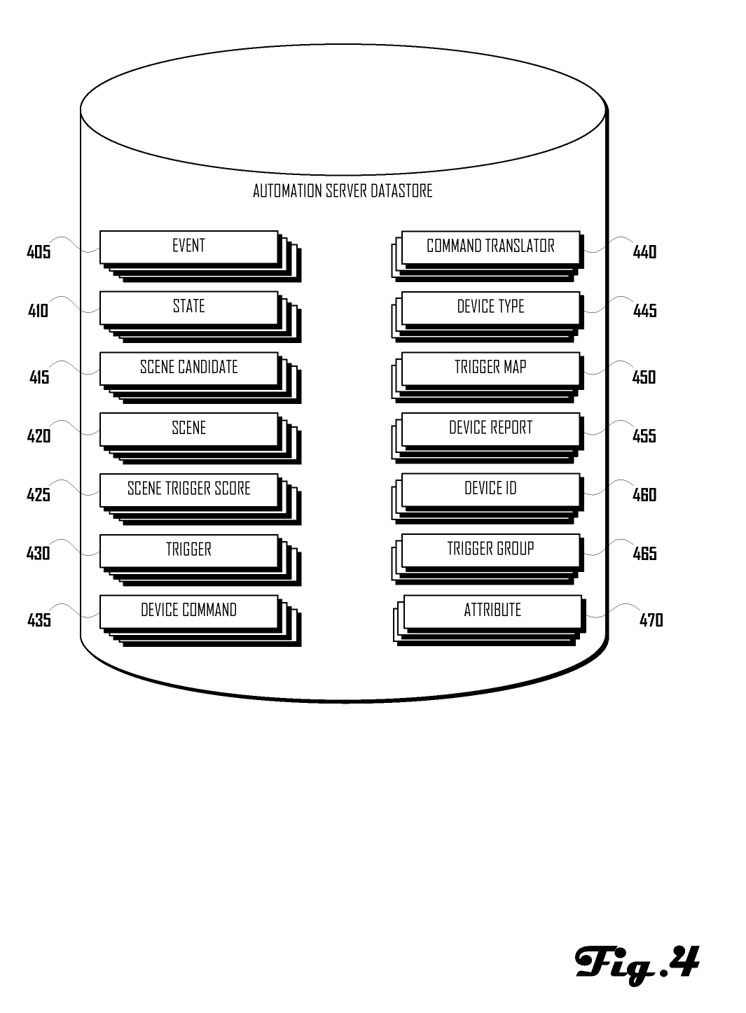

The Automation Server 300 may also comprise or communicate via Bus 320 with Automation Server Datastore 400, illustrated further in FIG. 4. In various embodiments, Bus 320 may comprise a storage area network (“SAN”), a high speed serial bus, and/or via other suitable communication technology. In some embodiments, Automation Server 300 may communicate with the Automation Server Datastore 400 via Network Interface 330. The Automation Server 300 may, in some embodiments, include many more components than those shown in this Figure. However, it is not necessary that all of these generally conventional components be shown in order to disclose an illustrative embodiment.

The Automation Server 300 is illustrated in FIG. 3 as comprising data groups for routines, such as routines for Device Registration Routine 500, the Scene Manager Routine 600, the Fitness Function Subroutine 700, and the Genetic Operator Subroutine 800. These routines are discussed at greater length herein, though, briefly, the Device Registration Routine 500 is a software routine which registers Devices and Controllers on first contact with the Automation Server 300 and periodically thereafter as necessary. The Scene Manager Routine 600 is a routine which receives and processes Device Reports 455, scores Scenes 420 according to the Fitness Function Subroutine 700, triggers Scenes 420 in response to Triggers 430 in Device Reports 455, and generates new Scenes 420 and Scene Candidates 415 via the Genetic Operator Subroutine 800. The Fitness Function Subroutine 700 scores the Scenes 420 according to various criteria—such as how long a Scene 420 was active for—developing a Scene Trigger Score 425. The Genetic Operator Subroutine 800 determines Scene Candidates 415.

Additional data groups for routines, such as for a webserver and web browser, may also be present on and executed by the Automation Server 300. Webserver and browser routines may provide an interface for interacting with the other computing devices illustrated in FIG. 1, such as with the Support Server 130, the Controllers 141, the Devices 145, and the Mobile Computer 170 (which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 4 is a functional block diagram of the Automation Server Datastore 400, according to one embodiment. The components of the Automation Server Datastore 400 are data groups used by routines and are discussed further herein in the discussion of other of the Figures.

In addition to the data groups used by routines illustrated in FIG. 4, login credentials and local instances of customer and user profiles may be stored in or be accessible to all of the computing devices illustrated in FIG. 1, such as in the Automation Server Datastore 300, the Support Server 130, the Controllers 141, the Devices 145, and the Mobile Computer 170.

The software routines and data groups used by the software routines may be stored and/or executed remotely relative to any of the computers through, for example, application virtualization and/or through utilization of the Support Server 130.

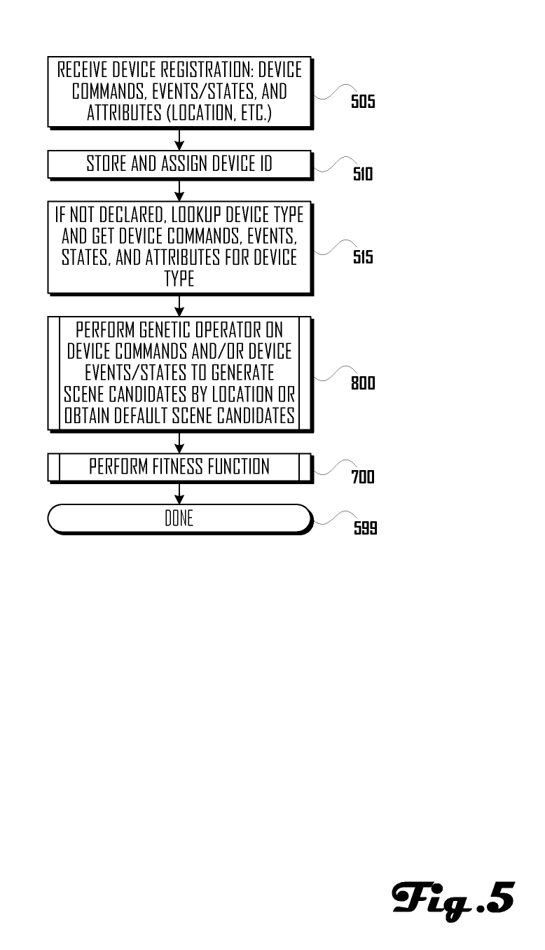

FIG. 5 illustrates a Device Registration Routine 500. At block 505 the Device Registration Routine 500 receives a communication from one or more Controllers 141, such as a first Controller 141 controlling a light bulb Device 145, which communication may be via the Device UI 375. The communication conveys information relating to the first Controller 141 and/or a first Device 145 attached to or part of the first Controller. The information conveyed may include Device Commands 435 which may be categorized as Events 405 and/or States 410 for the first Controller 141 and/or Device 145; as noted, the communication may or may not distinguish between an Event 405 or State 410, but may provide information, such as a list of Device Commands 435, which is categorized in this manner by the Automation Server 300 (such as according to the Device Type 445, the Device UI 375, and/or the Command Translator 440). The Event 405/State 410 information may comprise the then-current Event 405 and State 410 status of the first Controller 141 and/or first Device 145 and/or may comprise a list of Device Commands 435 available to be issued to or by the first Controller 141 and/or first Device 145.

At block 505 the first Controller 141 or a second Controller 141, such as the Mobile Computer 170, may also communicate Attributes 470 of the first Controller 141 and/or first Device 145, such as the Location 140 in which the first Controller 141 or Device 145 is present, a Device Type 445 of the first Controller 141 and/or first Device 145, identifier(s) of the first Controller 141 and first Device 145, such as a MAC address or other reasonably unique identifier for one or both of the first Controller 141 and first Device 145, a name of the Controller 141 or Device 145, and Attribute 470 or Attribute 470 parameters such as, for example, “Learn”(signifying that the Device or Controller participates in the Scene Manager Routine 600), “IsTrigger” (signifying that an Event 405 is a Trigger 430) or “Show” (signifying that the Controller or Device may be shown in the Human UI 370). The Mobile Computer 170 or other Controller 141 may be paired with the first Controller 141, such as by input of a code into one or both. The first Controller 141 and first Device 145 may also be paired with one another.

At block 510, the Device Registration Routine 500 may store the information received at block 505 and may assign a Device ID 460 to the first Device 145 and/or to the first Controller 141. The assigned Device ID 460 may be sent to the first Controller 141 and/or first Device 145 for use by such computer in future communications and/or the assigned Device ID 460 may be associated with the identifier Attribute 470 received at block 505.

At block 515, if not declared at block 505, the Device Registration Routine 500 may look up the Device Type 445 in a local or remote table or list of Device Types 445 (if a Device Type 445 was not obtained in block 505, this lookup may be performed after looking up a Device Type 445 corresponding to the reasonably unique identifier for one or both of the first Controller 141 and first Device 145 received at block 505) and obtain Device Commands 435, Events 405 and/or Events 405/Triggers 430 and States 410 associated with the Device Type 445 of the first Device. Alternatively, and as noted, at block 505 the Device Registration Routine 500 may lookup or receive identification of Device Commands 435, Events 405 and/or Events 405/Triggers 430, and States 410 associated with the first Device. As noted, one or more of the Events 405 may be Triggers 430 for Scene Candidates 415.

At block 800, the Device Registration Routine 500 may invoke the Genetic Operator Subroutine 800 to generate Scene Candidates 415 in relation to the Devices 145 and/or Controllers 141 for which information was obtained at step 505 and/or 515. Alternatively, the Device Registration Routine 500 may obtain a default set of Scene Candidates 415 for the Device Commands 435 and/or Events 405/Triggers 430 obtained at step 505 and/or 515.

At block 700, the Device Registration Routine 500 may invoke the Fitness Function Subroutine 700, to determine a Score for the Scene Candidates 415 generated at block 800. If this is the first iteration of the Fitness Function Subroutine 700 relative to a Device 145 and/or Triggers 430, all of the Scene Candidates 415 may assigned the same Scene Trigger Score 425 or a default set of Scene Trigger Scores 425 may be assigned to the Scene Candidates 415.

At block 599 the Device Registration Routine 500 may conclude.

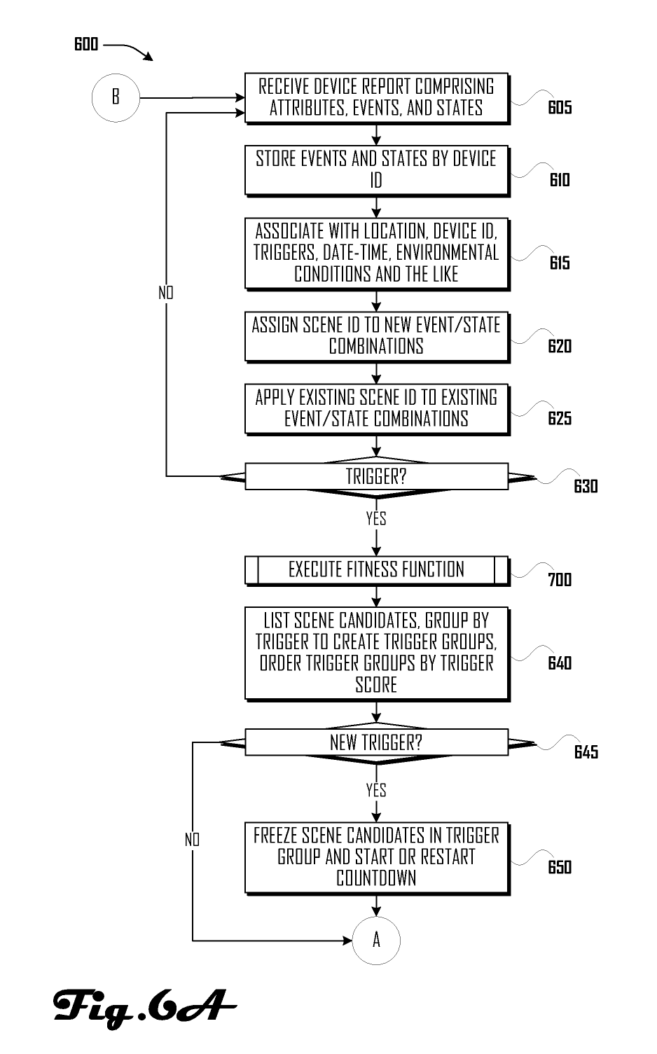

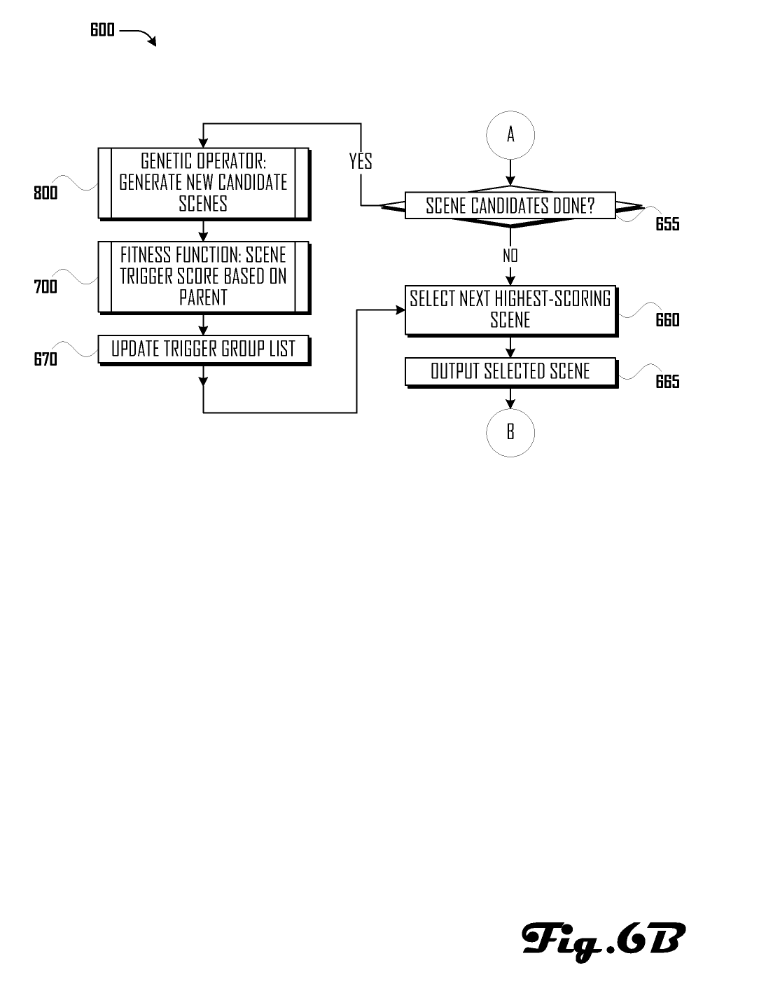

FIGS. 6A and 6B illustrate flow of an exemplary Scene Manager Routine 600. At block 605, the Scene Manager Routine 600 receives at least one Device Report 455 from at least one Controller 141. The Device Report 455 comprises a Device ID 460 or is associated with a Device ID 460 via the information collected and processed by the Device Registration Routine 500 (such as Attributes 470). The Device Report 455 comprises information conveying at least one of an Event 405 and/or State 410 (which may be communicated in the form of a Device Command 435 or a Device Command 435 acknowledgment). The Device Report 455 may comprise information regarding multiple Event 405 and/or State 410 records. The Device Report 455 may include or, via the Device ID 460 (and the Attributes 470 obtained by the Device Registration Routine 500), may be associated with Attributes 470, such as a Location 140, as well as the Device Type 445 of the Device 145 to which the Device Report 455 relates. As discussed elsewhere herein, the distinction between Events 405 and States 410 may or may not be reported in the Device Report 455; if not reported as such, the Scene Manager Routine 600 may categorize Events 405 and States 410 in the Device Report 455, such as based on the Device Type 445 or other information developed or obtained during the Device Registration Routine 500. The Device Report 455 may include or be associated with a date-time record. The Device Report 455 may be formatted according to an XML syntax and schema.

At block 610, the Event 405 and State 410 records may be stored according to, for example, the Device ID 460.

At block 615, the Scene Manager Routine 600 associates the stored Event 405 and State 410 information from the Device Reports 455 with, for example, a Location 140, whether the reported information comprises a Trigger 430, a date-time stamp, weather or other environmental condition reported by the Environmental Information Source 180, Trigger Map 450 parameters and the like.

At block 620, the Scene Manager Routine 600 may assign a Scene identifier, such as Scene 420 record, to new Event 405 and State 410 combinations for one or more Devices 145 which have not previously been reported. In this way, users can directly control Events 405 and States 410 at Devices 145, with new Scenes 420 being created for the user-created Event 405 and State 410 combinations.

At block 625, the Scene Manager Routine 600 may apply existing Scene identifiers, Scene 420 records, to Event 405 and State 410 combinations which previously existed. The Scene Manager Routine 600 may do this by comparing new Event 405 and State 410 combinations to existing Scene 420 records, which may comprise Event 405 and State 410 combinations.

At block 630, a determination may be made regarding whether the Device Report(s) 455 of block 605 contain an Event 405 which is also a Trigger 430.

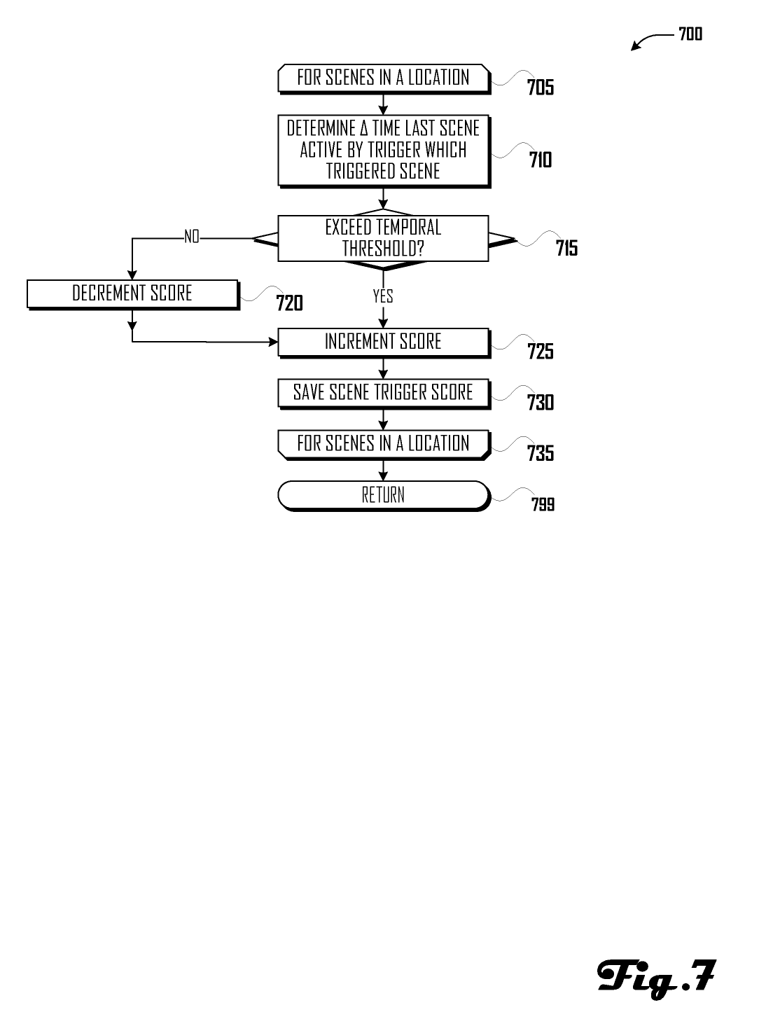

If affirmative at block 630, then at block 700, the Scene Manager Routine 600 executes the Fitness Function Subroutine 700 on the Scenes 420. The Fitness Function Subroutine 700 is discussed further in relation to FIG. 7. The Fitness Function Subroutine 700 scores the Scenes 420. The Fitness Function Subroutine 700 may be executed regardless of whether or not Events 405 and States 410 are received in the preceding blocks. The Fitness Function Subroutine 700 outputs a list of Scenes 420 and a Scene Trigger Score 425 for each.

At block 640, the output of the Fitness Function Subroutine 700, a list of Scenes 420 and Scene Trigger Scores 425 for each, may be grouped by Trigger 430 (or Event 405) or sets of related Triggers 430 (which may be determined by, for example, a Trigger Map 450), creating a Trigger Group 465, and the Trigger Groups 465 may be ordered (within each Trigger Group 465) by Scene Trigger Score 425. At this block or another block, Scenes 420 with a Scene Trigger Score 425 below a threshold may be removed from or flagged in the Scene 420 and Trigger Group 465 list(s).

At block 645, a determination may be made regarding whether the Device Report(s) 455 of block 605 contain a new Trigger 430, e.g., a Trigger 430 which is not a Trigger 430 subject to a countdown period (discussed further below). If not, then the Scene Manager Routine 600 may proceed to block 655. If so, then at block 650 the Scene Manager Routine 600 may freeze the then-current Scene Candidates 415 in the Trigger Group 465 associated with the Trigger 430 and may start a countdown. As described further herein, the countdown allows the Scene Candidates 415 in the Trigger Group 465 associated with the Trigger 430 to be iterated through. As discussed herein, Triggers 430 comprise Events 405 which have been identified as Triggers 430 by, for example, the Genetic Operator Subroutine 800.

Turning to FIG. 6B, at block 655 a determination (or equivalent) may be made regarding whether all of the Scenes Candidates 415 in the Trigger Group 465 have been iterated through within the countdown period begun at block 650. If the determination at block 655 is negative, then at block 660 the Scene Manager Routine 600 selects the next-highest scoring Scene 420 in the Scenes Candidates 415 of the Trigger Group 465, relative to the preceding Scenes Candidate 415 selected within the countdown period (for the first time within the countdown period, the next-highest scoring Scene 420 is the highest scoring Scene 420 in the Trigger Group 465).

At block 665 the Scene 420 selected at block 660 is implemented, such as by obtaining the Device Commands 435 comprising the Scene 420, translating the Device Commands 435 into the syntax native or unique to the Controller 141 or Device 145, such as via the Command Translator 440 records, and then transmitting the translated Device Commands 435 to the Controller(s) 141 for the Device(s) 145.

Proceeding from block 655, at block 800 a determination had been made at block 655 that all of the Scenes 420 in the Trigger Group frozen at block 650 had been iterated through within the countdown period and at block 800 the Genetic Operator Subroutine 800 is invoked to generate new Scene Candidates 415 for the Devices in the Location 140. This process is discussed at greater length in relation to FIG. 8.

If more than one Scene Candidate 415 is generated by the Genetic Operator 800, then at block 700, the Fitness Function Subroutine 700 (or an equivalent process) is invoked to develop Scene Trigger Scores 425 for the Scene Candidates 415, for example, based on the Scene Trigger Scores 425 assigned to the Scenes 420 used to generate the Scene Candidates 415.

At block 670 the Trigger Group 465 (from block 640) is updated to include the generated Scene Candidates 415, and the process continues at block 660, with the next highest-scoring Scene 420 being selected in ranked order.

Not shown, an escape or similar function may be provided to terminate the Scene Manager Routine 600.

In this way, users can create new Scenes 420 by setting Events 405 and States 410 in Devices 145; when an Event 405 is detected which is also determined to be a Trigger 430, which Trigger 430 may be, for example, a user toggling a wall switch which is also a Controller 141 and a Device 145, the Scene Manager Routine 600 understands the toggle to be a Trigger 430 in a Trigger Group 465 and implements the highest scoring Scene 420 in the Trigger Group 465. If the user does not want that Scene 420, then the user may press the wall switch again (another instance of the Event 405/Trigger 430) before the countdown clock for the frozen Trigger Group 465 has finished, causing the Scene Manager Routine 600 to implement the next-highest scoring Scene 420 in the Trigger Group 465. If the user does not want that Scene 420, then the user may press the wall switch again (another instance of the Event 405/Trigger 430), leading to the next-highest scoring Scene 420 in the Trigger Group 465. When all the Scenes 420 are exhausted and the user continues to press the wall switch, the Scene Manager 600 invokes the Genetic Operator 800 to generate new Scene Candidates 415 and adds them to the list of Scenes 420 in the Trigger Group 465, which the user can then settle on (by not causing Events 405 at the Device 145) or not (by causing Events 405 which are Triggers 430 for the active Trigger Group 465).

As noted above, the user is also able to directly set Events 405 and States 410 for Devices 145 in the Location 140; if a combination of Events 405 and States 410 is new, then a new Scene 420 will be created and scored by the Fitness Function Subroutine 700. Thus, when the user's behavior in a location follows a routine, existing Scenes 420 will be implemented. When the user's behavior in a location changes, new Scenes 420 are created, either by the Genetic Operator 800 or by the user setting Event 405 and States 410 for Devices 145, and the new Scenes 420 are scored. If the user's behavior over time follows the new, changed, pattern, then the new Scenes 420 become the new output.

FIG. 7 illustrates an example of the Fitness Function Subroutine 700 illustrated in FIG. 6. Blocks 705 through 735 may be performed for all Scenes 420 associated with a particular Location 140.

At block 710, the amount of time the last Scene 420 was active for is determined. At block 715 a determination (or equivalent) may be made regarding whether a temporal threshold for activity of the Scene 420 was exceeded. If the temporal threshold was exceeded, then at block 725 the Scene Trigger Score 425 for the Scene 420 may be incremented by an amount. If the temporal threshold was not exceeded, then at block 720 the Scene Trigger Score 425 for the Scene 420 may be decremented by an amount.

At block 730 the Scene Trigger Scores of the Scenes 420 may be saved.

FIG. 8 illustrates an example of the Genetic Operator Subroutine 800 illustrated in FIG. 6. At block 805, the Scenes 420 associated with a Location 140 are selected. Alternatively, the Scene Candidates 415 associated with a Trigger Group 465 may be selected.

At block 810 the Scenes 420 or Scene Candidates 415 with the highest Scene Trigger Score 425 may be selected. The threshold may, for example, be a numeric score or it may be a selection of a number of Scenes 420 or Scene Candidates 415, starting with the Scene 420 or Scene Candidate 415 with the highest Scene Trigger Score 425.

Blocks 815 and 820 present alternative or complementary examples of ways new Scene Candidates 415 may be generated. At block 815 the Device Commands 435 for Devices 145 in the selected Scenes 420 may be cross-combined and associated with Triggers 430 in the Location, such as Triggers 430 for the selected Scenes 420, producing a matrix of Scene Candidates 415 by Trigger 430. At block 820, a random selection of Device Commands 435 for Devices by Trigger 430 in the Location 140 may be generated, regardless of Event 405 and State 410 combinations in other Scenes 420. Not shown, Scene Candidates 415 generated at either block 815 or 820 and which are the same as the existing Scenes 420 may be eliminated.

At block 825 the generated Scene Candidates 415 are saved. Referring to FIG. 2, a Device in a Location has two Triggers 430, Trigger 205A and Trigger 205B. Each Trigger is associated with Scene Candidates generated by the process illustrated in FIG. 8. The generated Scene Candidates are added to the Trigger Group 465 list, such as at block 670, and are presented and cycled through or settled upon by the user, as discussed in relation to FIGS. 6A and 6B. FIG. 2 illustrates that two different Triggers 205A and 205B in one Location may be associated with the same Scene 420, in the example illustrated in FIG. 2, Scene 215A.

Following is a table of Scenes in a Location 140 comprising two Devices 145, which Devices 145 have three available power levels, 0, 50%, and 100%.

| | Device 1/Device 2 |
|---|---|
| | power levels |
| Scene 1 | 0/0 |
| Scene 2 | 50/0 |
| Scene 3 | 100/0 |
| Scene 4 | 0/50 |
| Scene 5 | 50/50 |
| Scene 6 | 100/50 |
| Scene 7 | 0/100 |
| Scene 8 | 50/100 |
| Scene 9 | 100/100 |

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A computer implement method of controlling an environmental control device, the method comprising:
at a first computer, receiving a first device report from a first environmental control device, which device report comprises at least one of event and state information for the first environmental control device;
sorting the device report by location and environmental control device;
defining a first scene comprising a first combination of device events and device status and a first scene trigger;
defining a second scene comprising a second combination of device events and device status and a second scene trigger;
creating a first scene trigger group comprising scenes associated with the first and second scene triggers; and
utilizing a fitness function to determining a scene trigger score for the scenes in the first scene trigger group.

2. The method according to claim 1, further comprising:
determining that the first or a subsequent device report comprises a scene trigger in the first scene trigger group;
selecting a scene in the first scene trigger group with the highest scene trigger score; and
implementing the selected scene with the highest scene trigger score.

3. The method according to claim 2, further comprising starting a countdown clock upon determining that the first or the subsequent device report comprises a scene trigger in the first scene trigger group.

4. The method according to claim 3, while the countdown clock has not elapsed, receiving a second device report comprising a scene trigger in the first scene trigger group and determining whether any scene candidates remain in the first scene trigger group.

5. The method according to claim 4, further comprising determining that at least one scene candidate remains in the first scene trigger group, selecting a scene in the first scene trigger group with the next highest scene trigger score, and implementing the selected scene with the next highest scene trigger score.

6. The method according to claim 4, further comprising determining that no scene candidate remain in the first scene trigger group, executing a genetic operator to generate new scene candidates, and including the new scene candidates in the first scene trigger group.

7. The method according to claim 6, further comprising utilizing the fitness function to determine scene trigger scores for the new scene candidates, and selecting the next scene candidate in the first scene trigger group which has the highest scene trigger score.

8. The method according to claim 6, wherein the genetic operator comprises selecting the scenes in the first scene trigger group with the highest scene trigger score, cross-combining the device commands for each device in each scene, and saving the result as scene candidates.

9. The method according to claim 6, wherein the genetic operator comprises selecting the scenes in the first scene trigger group with the highest scene trigger score, randomly combining the device commands in each scene, and saving the result as scene candidates.

10. The method according to claim 1, wherein the fitness function groups scenes by location and scene trigger, determines the length of time each scene was active for, and increments or decrements the scene trigger score for the scene if the length of time the scene was active for is greater or less than a temporal threshold.

11. The method according to claim 1, further comprising assigning a scene identifier to combinations of device events and device status which have not previously been received in a device report.

12. The method according to claim 1, further comprising assigning an existing scene identifier to combinations of device events and device status which have previously been received in a device report.

13. The method according to claim 1, wherein at least one of the first or second device reports comprises event and state information input into the environmental control device by a user.

14. The method according to claim 1, wherein at least one of the first or second device report comprises event and state information input into the environmental control device by an environmental control device controller.

15. The method according to claim 1, wherein the first and second scene triggers are the same and the first scene trigger group contains only scene triggers which are the same.

16. A non-transient computer-readable medium having stored thereon instructions that, when executed by a processor, configure the processor to:
receive a first device report from a first environmental control device, which device report comprises at least one of event and state information for the first environmental control device;
sort the device report by location and environmental control device;
define a first scene comprising a first combination of device events and device status and a first scene trigger;
define a second scene comprising a second combination of device events and device status and a second scene trigger;
create a first scene trigger group comprising scenes associated with the first and second scene triggers; and
utilize a fitness function to determining a scene trigger score for the scenes in the first scene trigger group.

17. A computer implement method of registering environmental control devices for use in an environmental control system, the method comprising:
at a first computer, receiving a first set of device commands and attributes for a first environmental control device;
assigning a first device identifier to the first environmental control device;
receiving a second set of device commands and attributes for a second environmental control device;
assigning a second device identifier to the second environmental control device;
wherein the first and second set of attributes comprise a common location;
for environmental control devices in the common location, performing a genetic operator on the sets device commands to generate scene candidates; and
performing a fitness function on the scene candidates to develop a scene trigger score.

18. The method according to claim 17, wherein the genetic operator comprises cross-combining the device commands available to each environmental control device.

19. The method according to claim 17, wherein the genetic operator comprises randomly combining the device commands available to each environmental control device.

20. The method according to claim 17, wherein the fitness function comprises assigning a default scene trigger score or the average scene trigger score for similar scenes in locations other than the common location.
